(19) United States
(12) Patent Application Publication
(10) Pub. No.: US 2012/0207478 A1
(43) Pub. Date: Aug. 16, 2012

(54) OPTICAL TRANSCEIVER INSTALLING CPU AND INTERFACE COMMUNICATING WITH UPPER DEVICE BY MDIO PROTOCOL

(75) Inventors: Hiromi TANAKA, Yokohama-shi (JP); Ryutaro FUTAMI, Yokohama-shi (JP)

(73) Assignee: SUMITOMO ELECTRIC INDUSTRIES, LTD., Osaka (JP)

(21) Appl. No.: 13/367,999

(22) Filed: Feb. 7, 2012

(30) Foreign Application Priority Data
Feb. 10, 2011 (JP) 2011-027200

(51) Int. Cl. G06F 13/42; H04J 14/02; H04B 10/02

(52) U.S. Cl. 398/79; 398/135

(57) ABSTRACT

An optical transceiver able to communicate with an upper device is disclosed. The optical transceiver distinguishes the peripheral interface from the CPU. The CPU monitors includes MDIO register that stores inner conditions of the optical transceiver. The peripheral interface is coupled with the upper device with the MDIO bus, and the CPU with the parallel bus. The upper device acquires one of the conditions by defining the address of the MDIO register and receiving data through the peripheral interface.

### CROSS REFERENCE TO RELATED APPLICATIONS

The present application is closely related to U.S. patent application Ser. No. 13/284,618 filed on Oct. 28, 2011, entitled “APPARATUS INSTALLING DEVICES CONTROLLED BY MDIO or SPI PROTOCOL AND METHOD TO CONTROL THE SAME,” the entire contents of which are incorporated herein by reference in its entirety.

### BACKGROUND OF THE INVENTION

1. Field of the Invention

The present invention relates to an optical transceiver that installs a CPU (Central Processing Unit) and a logic controller connected with the CPU by the MDIO (Management Data Input/Output) bus.

2. Prior Arts

A Japanese Patent Application published as JP-2004-153403A has disclosed an optical transceiver providing a transceiver IC and a peripheral IC. The transceiver IC is connected to an upper unit, which is usually a host system for the optical transceiver, by an MDIO bus; while, the transceiver IC is also connected to the peripheral IC. The peripheral IC monitors inner status of the transceiver and stores the monitored status therein. These monitored statuses are periodically reflected in an MDIO register implemented within the transceiver IC. This scheme inevitably requests the transceiver to repeat the transmission of the monitored data from the peripheral IC periodically to the transceiver IC. Once transmitted data to the MDIO register in the transceiver IC are sent to the upper unit; which leads time lag until the upper device recognizes the newest status of the transceiver.

### SUMMARY OF INVENTION

One aspect according to an embodiment of the invention relates to an optical transceiver configured to communicate with an upper device. The optical transceiver includes a CPU and an interface, where the interface is coupled with the external device via an MDIO bus, while, the interface is coupled with the CPU via a parallel bus.

The interface may be physically distinguished from the CPU. The interface may primarily manage the communication with the external device, while, the CPU may control devices implemented with the optical transceiver and collect conditions of the internal devices. Moreover, two devices, the interface and the CPU, are connected by the parallel bus and one of conditions collected by and stored in the CPU is fetched by the interface concurrent with the reception of command from the external device; accordingly, the external device may collect conditions within the optical transceiver with a shortened delay.

Another aspect of an embodiment of the invention relates to a method to write/read a data into/from an optical transceiver by an external device. The method may include steps of: decoding by the interface a first operation code involved in a first MDIO frame sent from the external device via an MDIO bus; setting an address on a parallel bus by the interface, when the first operation code is SET address; decoding a second operation code involved in the second MDIO frame sent next to the first MDIO frame; reading a data from the second MDIO frame, when the second operation code is WRITE data; and setting the data on the parallel bus by the interface to write the data into one of addresses of a register defined previously. A feature of the method of the embodiment is that the decoding the second operation code is performed by the interface concurrently with the setting the address on the parallel bus.

When the second operation code decoded by the interface is RED/A data, the process may include, instead of reading the data from the second MDIO frame, a step of reading the data stored in the one of addresses in the CPU, which is defined previously, and set on the parallel bus by the CPU; and another step of, instead of setting the data on the parallel bus, sending the data to the external device by the interface during the second MDIO frame.

### BRIEF DESCRIPTION OF DRAWINGS

Non-limiting and non-exhaustive embodiments of the present invention will be described with reference to the following figures, wherein like reference numerals refer to like parts throughout the various figures unless otherwise specified:

FIG. 1 is a functional block diagram of an optical transceiver according to an embodiment of the invention;

FIG. 2 is a block diagram of the optical transceiver concerning to the communication with an external device and that in the optical transceiver;

FIG. 3 is a timing diagram of the address set mode within the optical transceiver;

FIG. 4 is a timing diagram of the data write mode within the optical transceiver;

FIG. 5 is a timing diagram of the data read mode within the optical transceiver;

FIG. 6 exhibits one frame of the MDIO protocol between the external device and the peripheral interface;

FIG. 7 is a timing diagram of the data write mode between the external device and the CPU;

FIG. 8 is a timing diagram of the data read mode between the external device and the CPU; and

FIG. 9 is a timing diagram of the post-increment after read mode between the external device and the peripheral interface, and between the peripheral interface and the CPU.

### DESCRIPTION OF EMBODIMENTS

Next, some preferred embodiments according to the present invention will be described as referring to accompanying drawings. In the description of the drawings, the same numerals or symbols will refer to the same elements without overlapping explanation.

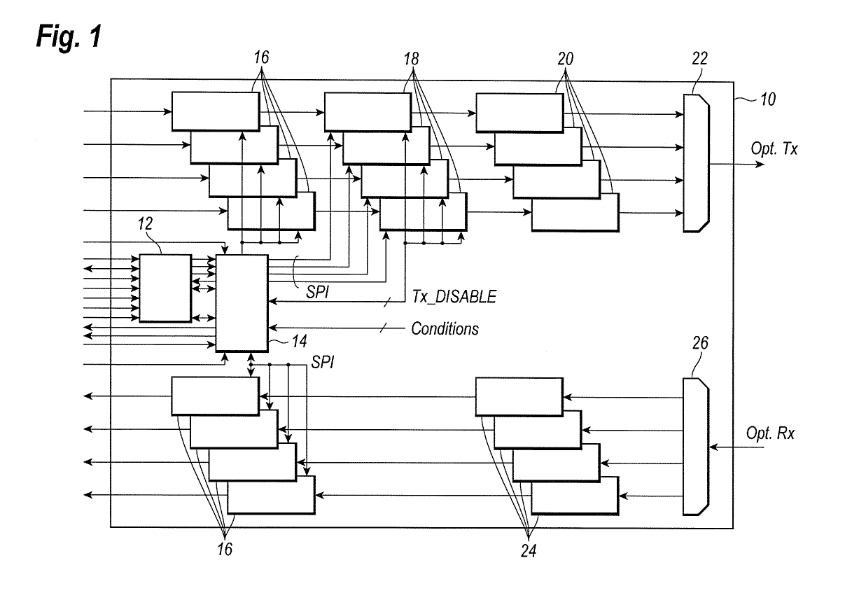

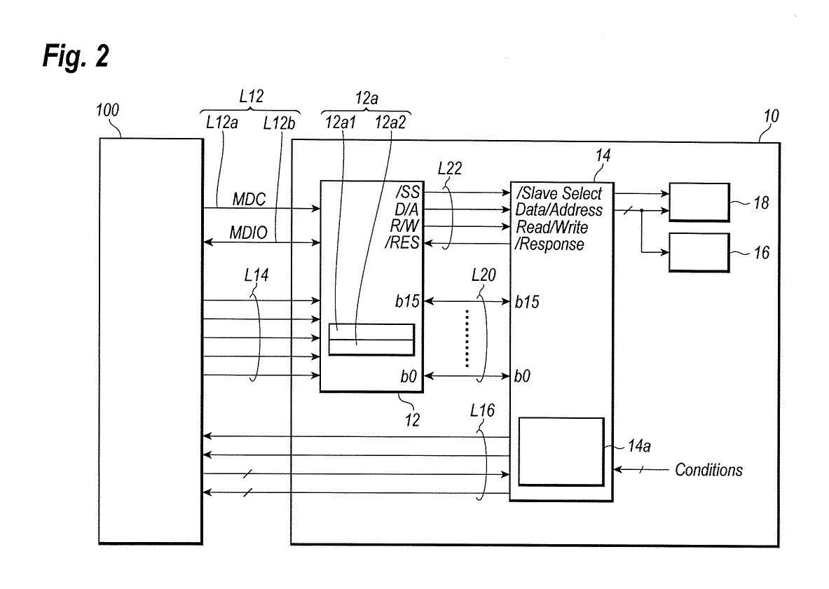

FIG. 1 is a block diagram of an optical transceiver 10 according to an embodiment of the invention; while, FIG. 2 is a functional diagram of an interface 12 and a CPU 14 coupled with an upper device 100, which is a host system when the optical transceiver 10 is a pluggable transceiver. Referring to FIGS. 1 and 2, the optical transceiver 10 may further provide a plurality of clock and data recoveries (CDR) 16, transmitter drivers 18, transmitter subassemblies (TOSA) 20, an optical multiplexer 22, receiver optical subassemblies (ROSA) 24, and an optical de-multiplexer 26.

The optical transceiver 10 of the present embodiment may provide four (4) sets of the transmission unit and four (4) sets of the receiver unit. Each set of the transmission units, which includes a CDR 16, a transmitter driver 18, and a TOSA 20, may emit light with a specific wavelength different from others. Also, one of the receiver units each including a ROSA 24 and a CDR 14 may receive light with a specific wavelength different from others. Thus, the optical transceiver 10 shown in FIGS. 1 and 2 may communicate with another optical transceiver by the signal light multiplexed by four (4) light each having a specific wavelength different from others.

The TOSA 20 may install a light-emitting device, typically a semiconductor laser diode (LD). Each light emitted from respective TOSAs 20 are multiplexed by the optical multiplexer 22, and this optical multiplexer 22 may emit the multiplexed light to an optical fiber. Each TOSA 20 is driven by the transmitter driver 18. That is, the transmitter driver may provide a driving current of the LD in the TOSA 20. The transmitter driver 18 may also control the emission power of the LD by, for instance, adjusting the magnitude of the driving current. Thus, the transmitter driver 18 may include a driver circuit and a control circuit.

Each of the transmitter driver 18 is connected to one of the CDRs 16; and the CDR 16 superposes the clock on a signal received from the upper device 100, and provides thus superposed signal to the transmitter driver 18. The transmitter may generate the driving current based on this superposed signal.

Each of the transmitter drivers 18 is coupled with the CPU 14 via a command line Tx_DISABLE to disable the transmitter driver 18. Each of the transmitter drivers 18 may be further coupled with the CPU 14 via a serial peripheral interface (SPI) line. The CDR 16 is also connected with the CDR 16 via SPI lines.

The ROSA 24 includes a light-receiving device, typically a photodiode (PD), and a trans-impedance amplifier (TIA) to convert a photocurrent generating by the PD into a voltage signal. The light entering the optical de-multiplexer 26 is divided thereby into four optical signals depending on the wavelengths. Each of the de-multiplexed optical signals is detected by the ROSA 24. Each of the ROSAs 24 is coupled with respective CDRs 16. The CDR 16 may eliminate clock components from the voltage signal provided from each ROSA 24 and output the reshaped signal to the upper device 100.

An arrangement between the CPU 14 and the interface 12 will be further described as referring to FIG. 2. The interface 12 has a type of the complex programmable interface 12 to manage a portion of the communication between the CPU 14 in the optical transceiver 10 and the upper device 100. The description below denotes the interface 12 as a CPLD.

The CPLD 12 is connected with the upper device 100 via MDIO bus L12 and five control lines L14 for defining port addresses in the CPLD 12. The MDIO bus L12 includes two lines, one of which is for transmitting the MDIO clock (MDC) L12a and the other is provided for the MDIO data L12b (MDIO). The latter line MDIO is the bidirectional line. The CPU 14 may be a type of, what is called, one chip processor, to control the TOSAs 20 and the ROSAs 24. The CPU 14 may monitor and collect inner conditions of the optical transceiver 10, and assert/negate alarms and conditions to the upper device 100 or the outside of the optical transceiver 10. As shown in FIG. 2, the CPU of the present embodiment may send the alarms thus monitored and generated to the upper device 100 via status lines L16.

The CPU 14 may implement with an MDIO register 14a to store a plurality of conditions each monitored by the CPU 14. The conditions stored thereat are, for instance, an inner temperature of the optical transceiver 10, a voltage of the inner power supply, bias current of respective TOSAs 20, optical power output from respective TOSAs, a temperature of the light-emitting device in respective TOSAs, and/or optical power received by respective ROSAs.

The communication between the CPLD 12 and the CPU 14 may be carried out via a bus L20. The embodiment shown in FIG. 2 has a parallel bus L20 including 16 bi-directional lines. Two devices, 12 and 14, may further communicate with four command lines L22 including a Slave Select/SS, an Data/Address D/A, a Read/Write R/W, and a Response/RES; where slash “/” added in the head of respective contexts means that the signal denoted by the following contexts has the negative logic, that is, the command denoted by the context is asserted when the signal line with the slash becomes LOW.

The CPLD 12 may acquire, via the parallel bus L20, the status data stored in one of addresses of the register 14a whose address is sent from the upper device 100. The CPLD 12 may implement with the registers 12a, one of which 12a1 may temporarily store the address defined by the upper device 100, while, the other 12a2 may store the status data transferred from the MDIO register 14a of the CPU 14.

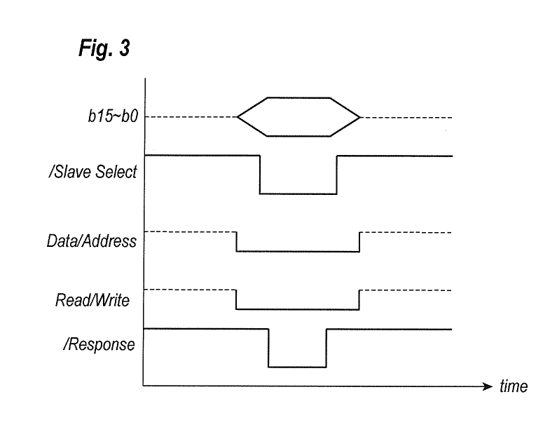

Next, algorithms of the communication between the CPLD 12 and CPU 14 will be described as referring to FIGS. 3 to 9. FIG. 3 shows timing diagrams to set an address of the MDIO register 14a defined by the upper device 100. The CPLD 12 first sets two commands, Data/Address (D/A) and Read/Write (R/W), on the command line L22. The former command D/A indicates that an address is active in the parallel bus L20 during the LOW period, while, a data is set therein during the HIGH period. Accordingly, the command line D/A is set LOW in advance to the practically setting the address on the line L20.

The command line R/W means that the write operation is done during the LOW period, while, the read operation is done during the HIGH period. Accordingly, the command line R/W is also set LOW in advance to the practical setting of the data on the line L20.

The CPLD 12 subsequently sets the address, which is sent from the upper device 100, on the parallel bus L20, and asserts the slave select/SS by reversing it to LOW level. Triggered by the falling edge of the slave select/SS, the CPU 14 carries out a process for the interruption and concurrently sets the response/RES in LOW to indicate that the CPU 14 is under the interruption process. The CPU 14 may decide that a data on the parallel bus L20 is an address by the command D/A and sets the inner address of the CPU 14 accordingly by the command R/W.

The CPLD 12 holds the data on the parallel bus L20 during the status/RES is LOW. Detecting the leading edge of the response/RES, the CPLD 12 may decide that the CPU 14 completes the interruption, and negates the slave select/SS to HIGH. Thus, the operation to write the inner address in the CPU 14 is completed.

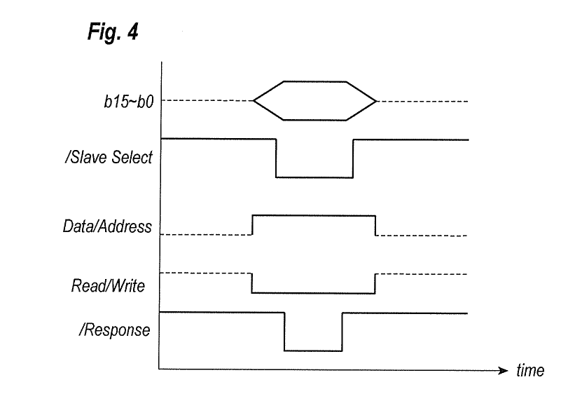

FIG. 4 shows a timing diagram of WRITE data in the CPU 14 by the CPLD 1D, which corresponds to an operation to write data in an address within the MDIO register 14a. The CPLD 12 first sets the command D/A in HIGH, which means that a data to be set on the parallel bus L20 is a data, and the command R/W in LOW, which means the operation is WRITE mode. Then, the CPLD 12 sets the data to be written on the parallel bus L20. Subsequently, the CPLD 12 asserts the slave select/SS to interrupt the CPU 12.

Then, the CPU 14 detects the assertion of the slave select/SS to begin the interruption procedures by reversing the response/RES to LOW. The CPU 14, acknowledging the commands, D/A and R/W, receives the data on the parallel bus L20 and stores them in the MDIO register 14a whose address is defined in advance to the present WRITE procedure.

The CPU 14 negates the response/RES after the fetched data is written in the MDIO register 14a, and the CPLD 12, by detecting the negation of the response/RES, reverses the slave select/SS to complete the process.

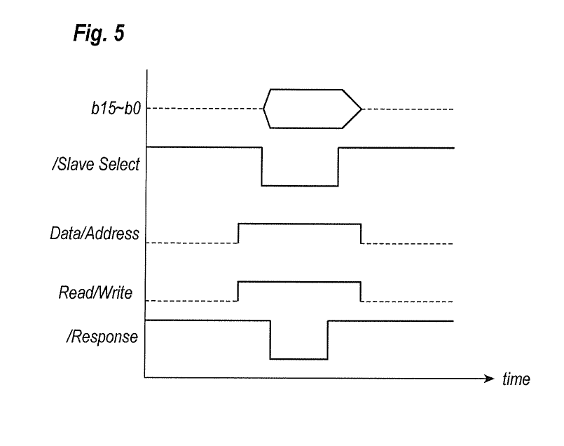

FIG. 5 shows a timing chart of the process to read a data from the MDIO register 14a of the CPU 14 by the CPLD 12. The CPLD 12 first sets the commands, D/A and R/W, in HIGH, which means that a data to be set on the parallel bus L20 is a data and the mode is READ; then asserts the slave select/SS. The CPU 14, receiving the slave select/SS, reverses the response/RES to LOW and sets a data on the parallel bus L20. The CPLD 12, acknowledging the response/RES, fetches the data on the parallel bus L20. The CPLD 12 negates the slave select/SS after fetching the data to complete the procedures. The data fetched by the CPLD 12 is stored in one of the data register 12a2 in the CPLD 12 to provide the upper device 100 through the MDIO bus L12. A feature of the process according to embodiments, the CPU 14 automatically increases the address of the MDIO register 14a by one independent of the operation next provided from the CPLD 12.

The parallel bus L20, as described above, is the type of the bi-directional line, that is, the CPLD 12 becomes the output port and the CPU 14 is the input port when the command is the SET address and the WRITE data; while, the CPU becomes the output port and the CPLD 12 is the input port when the command is the READ data.

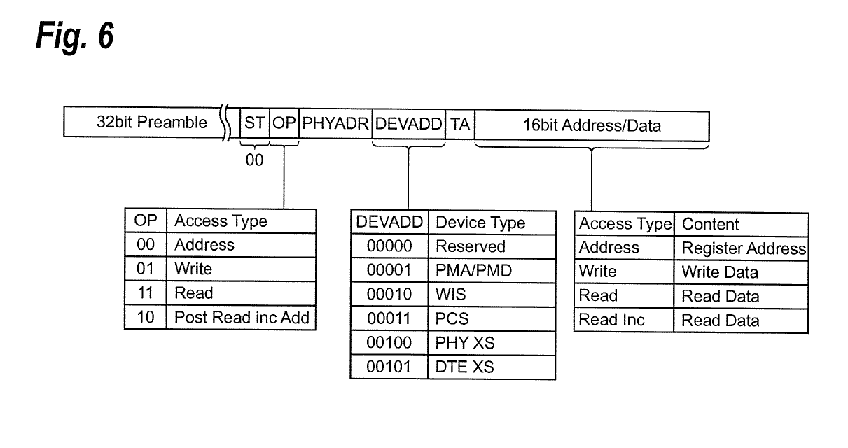

Next, the data format of the MDIO protocol between the CPLD 12 and the upper device will be described. FIG. 6 shows an example of the MDIO format following the rule defined by IEEE 802.3 clause 45 for CFP MSA Management Interface Specification. The format comprises, as shown in FIG. 6, 32-bits preamble, 2-bits start bit ST, 2-bits operation code OP, 5-bits physical port address PHYD/AR, 5-bits MDIO device address DEVD/AD, 2-bits turn-around bit TA, and 16-bits address/data, where the arrangements shown in FIG. 6 is often called as the MDIO frame.

When the device controlled by the MIDO protocol is the optical transceiver 10, the physical port addresses PHYADR are given by PGYADR0 to PHYADR4 and the MDIO device address DEVADR is assigned to be ‘000001’ (PMA/PMD). The operation code OP has four modes of: SET address, Write data, READ data, and READ data with post-increment of address (POST READ INC ADD).

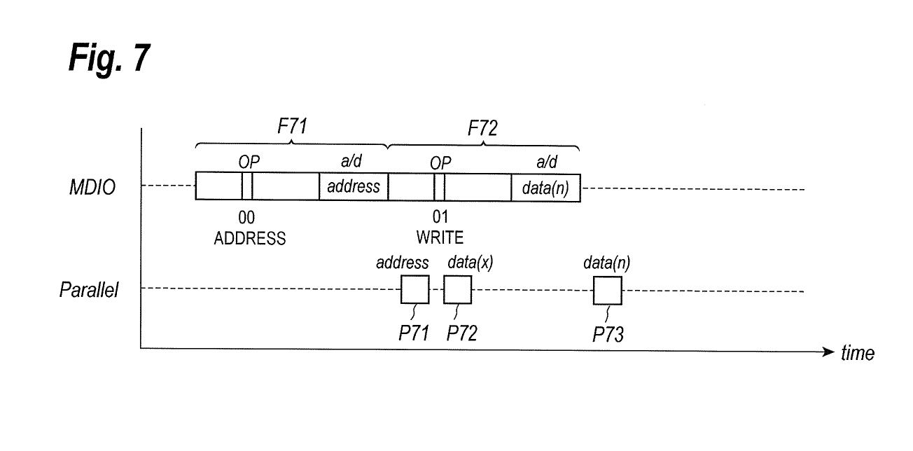

The MDIO protocol between the CPLD 12 and the CPU 14, and the communication between the CPLD 12 and the CPU 14 are described as referring to FIGS. 7 to 9. FIG. 7 is a timing chart for the address set and the WRITE data between the CPLD 12 and the upper device 100, and between the CPLD 12 and the CPU 14.

In those modes, the upper device 100 first sends the MDIO frame F71 shown in FIG. 6 to the CPLD 12 through the MDIO bus L12. The operation code OP of the frame F71 is ‘00’ (SET address) and 16-bits address/data sets the address. In FIGS. 7 to 9, a left block of the single MDIO frame denotes from the preamble to the turn-around bit TA, while, the right block thereof means 16-bits address/data subsequent to the turn-around bit TA in FIG. 5.

The CPLD 12, after receiving the first MDIO frame F71, sets the address of the MDIO register 14a in the CPU 14 by the protocol shown in FIG. 3. Specifically, the CPLD 12 first decodes the MDIO frame F71 and decides that the operation is the SET address and 16-bits data subsequent to the turn-around bit TA is the address. The CPLD 12 then sets this address on the parallel bus L20 at the timing P71, which forces the CPU 14 to set the address of the internal MDIO register 14a. This process to set the address by the CPU 14 is carried out during the period of the second frame F72 subsequent to the frame F71.

The upper device 100 sends the next MDIO frame F72 to the CPLD 12 via the MDIO bus L12. The frame F72 defines the operation code OP to be ‘01’, namely, WRITE operation, and 16-bits data subsequent to the turn-around bit TA is a practical data to be written. During the reception of the second frame F72, an undefined data stored in the MDIO register 14a whose address is set in the immediate timing P71, appears on the parallel bus L20 in the timing P72; but the CPLD 12 carried out no process for the data on the parallel bus L20.

After receiving the second frame F72, the CPLD 12 writes the data just received from the frame F72 by the procedures described in FIG. 4. Specifically, the CPLD 12 first decodes the command in the frame F72; acknowledges the command is WRITE data and 16-bits data is a data to be written; and sets this data on the parallel bus L20. The CPU 14 fetches the data one the parallel bus L20 to revise the MDIO register 14a whose address is set in the immediate frame F71. The revise of the register 14a is carried out in the period P73 next to the frame F72.

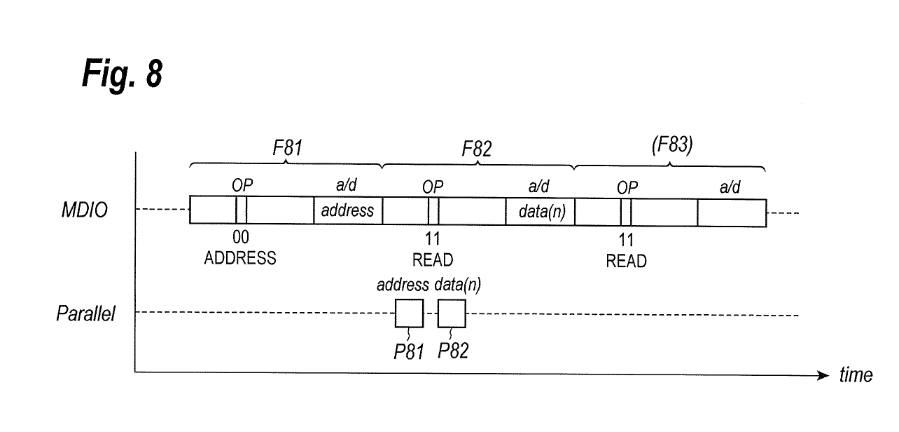

FIG. 8 shows a timing chart for the upper device 100 to read data from the MDIO register 14a in the CPU 14. The upper device 100 first sends the MDIO frame F81 to the CPLD 12, where the frame F81 includes the operation code OP of ‘00’ corresponding to the command of SET address and 16-bits address data in the end thereof. The CPLD 12, receiving the first frame F81, executes the process shown in FIG. 3. That is, decoding the command of the frame F81 to be SET address, the CPLD 12 sets the 16-bits data on the parallel bus L20. The CPU 14, fetching the address on the parallel bus L20, sets the address of the MDIO register 14a at the period P81. The period P81 overlaps with a period from the pre-amble to the turn-around bit TA in the next MDIO frame F82.

The upper device 100 continuously sends the MDIO frame F82 subsequent to the firs frame F81 on the MDIO bus L12. The operation code in the second frame F82 is set to be ‘11’, which means the operation is READ data. Concurrently with the reception of the frame F82 from the upper device 100, the CPU 14 may sets the data stored in the MDIO register 14a whose address is defined at the immediate period P81 on the parallel bus L20 at the period P82 just after the address-setting period P81. Then, the data fetched from the MDIO register 14a in the CPU 14 may be sent to the upper device 100 by setting on the MDIO bus at the data period of the second frame F82. Thus, two periods, P81 and P82, overlaps with the period from the preamble to the turn-around bit TA of the second MDIO frame F82.

Even when the upper device 100 sends another MDIO frame after the second MDIO frame F82, which includes the command of READ data, the data set on the 16-bits data field subsequent to the turn-around bit TA of the MDIO frame will be invariant, because no MDIO frames including the command of SET address are sent to the CPLD 12.

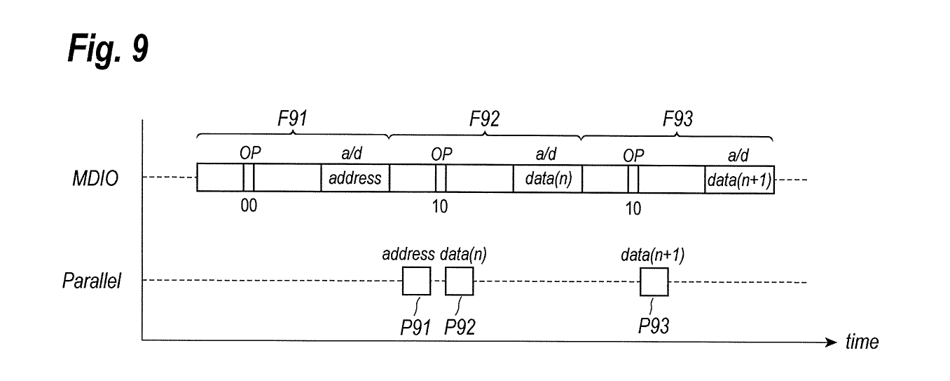

By contrast, the data in the MDIO register 14a may be continuously fetched in the POST READ INC AD mode. FIG. 9 is a timing chart of this mode between the upper device 100 and the CPLD 12, and between the CPLD 12 and the CPU 14. The upper device 100 first sends the frame F91 including the operation code OP of ‘00’ and the 16-bits address data in the address/data field. The CPLD 12, receiving the frame F91, sets the address in the address/data field on the parallel bus L20. The CPU 14, fetching the address on the parallel bus L20, sets the address of the MDIO register 14a at the period P91; and the CPU 14 puts one of the data in the MDIO register 14a, on the parallel bus L20 at the timing P92 subsequent to the address setting period P91.

The upper device 100 sends the second frame F92 to the CPLD 12 independent of the communication between the CPLD 12 and the CPU 14 via the parallel bus L20. The second frame F92 includes the operation code of ‘10’, which means that the operation is POST READ INC AD, namely, the address of the MDIO register 14a is always incremented by one after reading. The CPU 14, where the parallel bus L20 sets the address of the MDIO register 14a, sets the data defined by this address at the period P92. Two periods, P91 and P92, overlap with a period for the CPLD 12 to receive from the preamble to the turn around bit of the next frame F92 from the upper device 100. Then, during the period for the address/data of the frame 92, the CPLD 12 sends the data get from the CPU 14 back to the upper device 100. Concurrently, the CPU 14 automatically increases the address for the MDIO register 14a by one just after the CPLD 12 negates the slave select/SS in HIGH.

Subsequently, the upper device 100 sends the frame F93 to the CPLD 12, where the frame F93 also includes the operation code OP of ‘10’. Because the CPU 14 revises the data on the parallel bus L20 just after the period P92 without receiving the new address, the new data corresponding to the address incremented by one from the former address is fetched by the CPLD 12 during the period P93 and send to the upper device 100 in the data/address period of the frame F93. Although FIG. 9 exhibits that the period P93 succeeds the fetching of the operation code in the frame F93, the CPLD may get the new data during the period of the data/address in the frame F92 and the preamble in the frame F93. The CPU may increment the address of the MDIO register 14a again after the CPLD 12 negates the slave select/SS of the period P93.

Thus, the optical transceiver according 10 to the embodiment described above, the CPU 14 includes the MDIO register 14a for storing the inner conditions of the optical transceiver 10. When the upper device 100 sends a command to acquire one of the conditions, the upper device 100 may define the address of the MDIO register 14a through the CPLD 12, the CPU 14 sets the condition defined by the address of the parallel bus L20, and the CPLD 12 sends the data on the parallel bus L20 back to the upper device 100. The upper device 100 may acquire the present status of the optical transceiver 10 with a shortened delay time.

In the foregoing detailed description, the method and apparatus of the present invention have been described with reference to specific exemplary embodiments thereof. However, it will be evident that various modifications and changes may be made thereto without departing from the broader spirit and scope of the present invention. The present specification and figures are accordingly to be regarded as illustrative rather than restrictive.

We claim:

1. An optical transceiver configured to communicate with an upper device, comprising:
a central processing unit (CPU) including a register that stores a plurality of present conditions within the optical transceiver; and
an interface coupled with the upper device via a management data input/output (MDIO) interface bus and with the CPU via a parallel bus,
wherein one of the conditions stored in the register of the CPU is acquired by the external device through the parallel bus, the interface and the MDIO bus.

2. The optical transceiver of claim 1,
wherein the CPU is independent of the interface.

3. The optical transceiver of claim 1,
further including a plurality of transmitter subassemblies (TOSAs) each outputting an optical signal with a wavelength different from others, an optical multiplexer for multiplexing the optical signals, an optical de-multiplexer for de-multiplexing an input optical signal including a plurality of wavelengths into a plurality of optical signals each having the wavelength different from others, and a plurality of receiver subassemblies (ROSAs) each receiving one of the optical signals,
wherein the present conditions includes a temperature in the optical transceiver, a voltage of a inner power supply, a bias current of the TOSA, an optical output power of the TOSA, a temperature of the TOSA, and/or an optical input power of the ROSA.

4. The optical transceiver of claim 1,
wherein the register included in the CPU has a plurality of addresses each storing one of the present conditions.

5. The optical transceiver of claim 4,
wherein the interface includes a register having at least two addresses, one of the addresses storing the one of addresses of the register of the CPU, and the other of the addresses storing a data read from the one of the addresses of the register.

6. The optical transceiver of claim 1,
wherein the interface is further coupled with the CPU through 5 bits command lines including a slave select, a read/write, a data/address, and a response, the slave select, the read/write and the data/address being sent from the interface to the CPU, and the response being sent from the CPU to the interface.

7. The optical transceiver of claim 1,
wherein the CPU operates as a slave device in a function to communicate with the interface.

8. A method to write a data into a register provided in an optical transceiver by an external device, comprising steps of:
decoding a first operation code included in a first MDIO frame by the interface, the first MDIO frame being sent from the external device;
setting an address by the interface, when the first operation code is SET address, on a parallel bus connecting the interface with a central processing unit (CPU) concurrently with a reception of a second MDIO frame next to the first MDIO frame by the interface;
decoding a second operation code including in the second MDIO frame by the interface;
reading a data from the second MDIO frame when the second operation code is WRITE data; and
setting the data on the parallel bus by the interface to write the data set thereon into one of addresses of the register defined previously by the CPU.

9. A method to read at least a data from an optical transceiver by an external device, comprising steps of:
decoding a first operation code included in a first management device input/output (MDIO) frame by an interface, the first MDIO frame being sent from the external device by the interface;
setting an address by the interface, when the first operation code is SET address, on a parallel bus connecting the interface with a central processing unit (CPU);
reading, by the interface, a data stored in the address of a register in the CPU and set on the parallel bus by the CPU; and
sending the data to the external device by the interface during a second MDIO frame next to the first MDIO frame.

10. The method of claim 9,
further including a step of:
increasing the address of the register by one by the CPU after the data previously set on the parallel bus is read by the interface.

11. The method of claim 10,
further including steps of:
decoding a third operation code included in a third MDIO frame next to the second MDIO frame;
reading, by the interface, a data stored in an address increased by one from the address previously set when the third operation code is POST READ INCREMENT ADDRESS; and
sending the data to the external device by the interface during the third MDIO frame.

12. The method of claim 9,
wherein the interface includes a register having at least two addresses,
wherein the method further includes steps of:
storing the address in one of the addresses of the register in the interface after the step of decoding the first operation code; and
storing the data in another of the addresses of the register in the interface after the step of reading the data on the parallel bus by the interface.
